(19) United States
(12) Patent Application Publication
(10) Pub. No.: US 2014/0009449 A1
(43) Pub. Date: Jan. 9, 2014

(54) DISPLAY METHOD AND APPARATUS IN TERMINAL HAVING FLEXIBLE DISPLAY PANEL

(71) Applicant: Samsung Electronics Co., Ltd., Gyeonggi-do (KR)

(72) Inventor: Jongwoon JANG, Gyeongsangbuk-do (KR)

(21) Appl. No.: 13/934,603

(22) Filed: Jul. 3, 2013

(30) Foreign Application Priority Data
Jul. 3, 2012 (KR) 10-2012-0072085

(51) Int. Cl. G09G 3/00

(52) U.S. Cl. CPC G09G 3/00
USPC 345/204

(57) ABSTRACT

A display method in a terminal having a flexible display panel adjust for a distorted image due to bending of the flexible display panel. A degree of bending of a flexible display panel is calculated. A control unit determines whether the flexible display panel is bent based on the calculated degree of bending. The control unit determines whether the flexible display panel is convex or concave if the flexible display panel is bent, and the original image information is transformed by gradually decreasing a MAGNITUDE of image information toward a center from an outer portion when the flexible display panel is convex, and transforming the image information by gradually increasing the MAGNITUDE of the image information toward the center from the outer portion when the flexible display panel is concave. The displayed image information is transformed to correspond respectively in accordance with the flexible display panel being convex or concave.

### CLAIM OF PRIORITY

This application claims the benefit under 35 U.S.C. §119(a) from a Korean patent application filed on Jul. 3, 2012 in the Korean Intellectual Property Office and assigned Serial No. 10-2012-0072085, the entire disclosure of which is hereby incorporated by reference in its entirety.

### BACKGROUND

1. Field of the Invention

The present invention relates to a display method and apparatus in a terminal having a flexible display panel. More particularly, the present invention relates to a method and apparatus for displaying images on the flexible display panel.

2. Description of the Related Art

As electronic devices have become more lightweight and simple, a touch screen having a touch panel and a display panel, which are integrally formed with each other, has been widely used as a display unit of the electronic devices. Recently, there has been focus on development of a flexible display panel.

The flexible display panel is provide to replace a glass substrate that surrounds a liquid crystal with a plastic film in a liquid crystal display (LCD) and an organic light emitting diode (OLED), thereby making it possible to fold and unfold the display panel, something that was not possible with conventional display panels. The flexible display panel is strong against impact as well as thin and light. In addition, the flexible display panel may get bent or stooped and may be formed in various forms. Further, the flexible display panel has slim and lightweight design that is unbreakable even in the case of dropping the panel, therefore making it easier to handle. In addition, the flexible display panel may be formed to have a curved shape, thereby making it possible to expand an application range of a display.

However, in the case in which the flexible display panel is bent, a phenomenon occurs that an image is distorted. In other words, since the image far from a field of view looks to be small and the image close to the field of view relatively looks to be large, the image appears as a distorted image, unlike the original image.

### SUMMARY

The present invention has been made at least in part in view of the above problems, and provides a display method and apparatus by displaying on the flexible display panel transforming an image information that corresponds to a degree of bending of a flexible display panel, such that the image is not distorted even in the case in which the flexible display panel is bent.

In accordance with an exemplary aspect of the present invention, a display method in a terminal having a flexible display panel, includes: calculating a degree of bending of a flexible display panel; determining whether the flexible display panel is bent based on the calculated degree of bending; determining whether the flexible display panel is convex or concave if the flexible display panel is bent; transforming image information by gradually decreasing a MAGNITUDE of image information toward a center from an outer portion when the flexible display panel is convex, and transforming the image information by gradually increasing the MAGNITUDE of the image information toward the center from the outer portion when the flexible display panel is concave; and displaying the image information transformed so as to correspond to a case in which the flexible display panel is convex or the image information transformed so as to correspond to a case in which the flexible display panel is concave.

In accordance with another exemplary aspect of the present invention, an apparatus in a terminal having a flexible display panel, the apparatus includes: a flexible display panel; a transformation sensor sensing a transformation of the flexible display panel by including sensors installed on the flexible display panel; and a control unit configured to control the flexible display panel based on transformation information received from the transformation sensor, wherein the control unit controls the flexible display panel to calculate a degree of bending of the flexible display panel, to determine whether the flexible display panel is bent based on the calculated degree of bending and whether the flexible display panel is convex or concave when determining the flexible display panel is bent, transform image information by gradually decreasing a MAGNITUDE of the image information toward a center from an outer portion when the flexible display panel is convex, transform the image information by gradually increasing the MAGNITUDE of the image information toward the center from the outer portion when the flexible display panel is concave, and display the image information transformed to correspond to a case in which the flexible display panel is convex, or display the image information transformed to correspond to a case in which the flexible display panel is concave.

### BRIEF DESCRIPTION OF THE DRAWINGS

The exemplary objects, features and advantages of the present invention will become more apparent to a person of ordinary skill in the art from the following detailed description in conjunction with the accompanying drawings, in which:

FIG. 1 is a block diagram of an apparatus according to an exemplary embodiment of the present invention;

FIG. 2 is a diagram illustrating an arrangement of a transformation sensor according to an exemplary embodiment of the present invention;

FIG. 3 is a diagram illustrating image information providing to a user through a relatively flat display panel;

FIG. 4 is a diagram illustrating the case in which the display panel is bent to be convex;

FIG. 5 is a diagram illustrating the case in which the display panel is bent to be concave;

FIG. 6 is a flowchart illustrating exemplary operation of a display method according to an exemplary embodiment of the present invention; and

FIG. 7 is a flowchart illustrating exemplary operation of a transformation method of image information according to an exemplary embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

A method and an apparatus of the present invention may be applied to various devices that include but are not limited to multimedia devices having a flexible display panel. For example, the multimedia devices may be a smart phone, a tablet PC, a note book PC, a desktop PC, TV, a navigation apparatus, a video phone, and the like. In addition, the method and the apparatus of the present invention may be also applied to many other types of devices (e.g., a refrigerator having both of communication function and a touch screen) in which the multimedia devices are integrated.

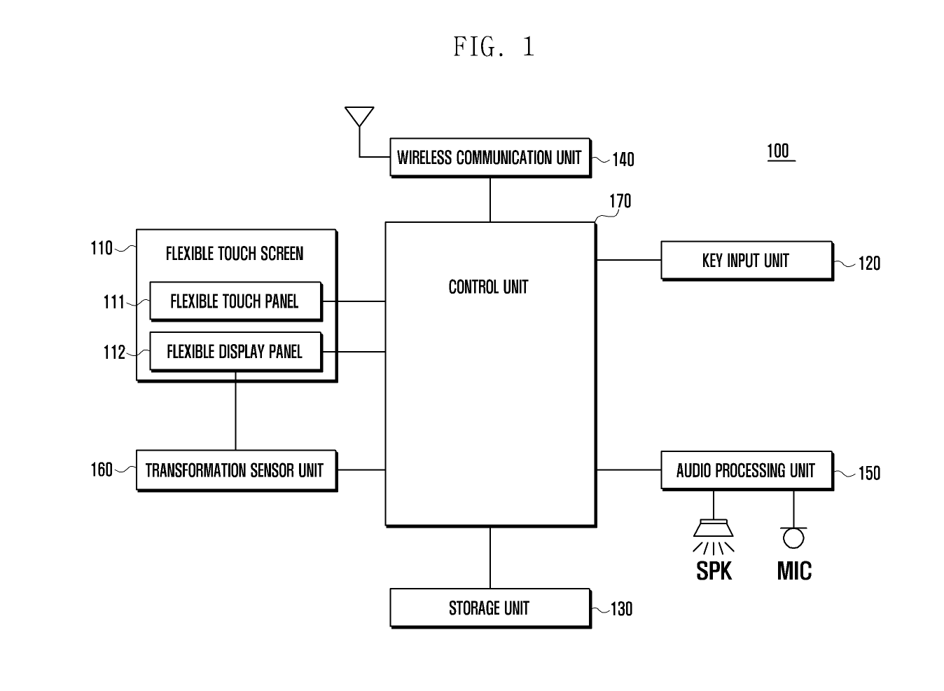

FIG. 1 is a block diagram of an apparatus according to an exemplary embodiment of the present invention.

Referring now to FIG. 1, the apparatus 100 according to the exemplary embodiment of the present invention is configured to include a flexible touch screen 110, a key input unit 120, a storage unit 130, a wireless communication unit 140, an audio processing unit 150, a speaker (SPK), a mike (MIC), a transformation sensor 160, and a control unit 170.

The flexible touch screen 110 (hereinafter, referred to as ‘touch screen’) includes a flexible touch panel 111 (hereinafter, referred to as ‘touch panel’) and a flexible display panel 112 (hereinafter, referred to as ‘display panel’) in order to provide a user interface for interaction with the user. The flexible touch panel 111, which is a flexible film type, may be placed on the display panel 112. More specifically, the touch panel 111 can be implemented as an add-on type positioned on the display panel 112, and an on-cell type or an in-cell type inserted in the display panel 112.

The flexible touch panel 111 serves to generate an analog signal (for example, touch event) in response to the user's gestures for the touch panel 111 and performs an analog-digital (A/D) conversion of the analog signal to transfer to control unit 170. The control unit 170, which comprises hardware such as a processor, microprocessor or microcontroller detects the user's gestures from the transferred touch event. In other words, the control unit 170 detects a touch point, a touch moving distance, a touch moving direction, a touch speed, and a touch pressure to control the above-mentioned configurations. The user's gestures are mainly divided into a touch and a touch gesture. Further, the touch gestures may include, for example, a tap, a double tap, a long tap, a drag, a drag & drop, a flick, a press, and the like. Here, the touch means an operation that user contacts by using a touch input (for example, a finger or a stylus pen) on any one point of the screen, the tap refers to an operation to touch-off the touch input from the corresponding point without moving of the touch input after touching any one point thereof, the double tap refers to an operation which continuously taps twice any one point, the long tap refers to an operation to touch-off the touch input from the corresponding point without moving of the touch input after touching relatively longer than the tap, the drag means an operation to move the touch input means in a predetermined direction while touching any one point, the drag-and-drop refers to an operation to drag and touch-off the touch input, and the flick refers to an operation that the touch input is rapidly moved like a flip as compared with the drag and is then touched off. The press refers to an operation that user touches any one point and presses a corresponding point using the touch input. That is, the touch refers to a state of contacting with the touch screen or coming within a predetermined distance of the touch screen such as to be recognized as a contactless touch, and the touch gesture refers to a motion of touch from touch-on to touch-off the touch screen. The touch panel 111 includes a pressure sensor to sense the pressure of the touched point. The sensed pressure information is transferred to the control unit 170, and the control unit 170 can classify the touch and the press based on the sensed pressured information. In the touch panel 111, a resistive type, a capacitive type, an electromagnetic induction type, and the like may be applied.

Under the control of the control unit 170, the flexible display panel 112 converts the image data received from the control unit 170 into the analog signal to display thereon. In other words, the flexible display panel 112 may display various screens, for example, a lock screen, a home screen, an application (‘App’) execution screen, a keypad screen, and the like according to the use of the apparatus 100. The lock screen may be defined as the image displayed on the display panel 112 when the display panel 112 is turned on. When the touch gesture for unlocking is detected, the control unit 170 may change the image displayed on the display panel from the lock screen to the home screen, or the app execution screen. The home screen may be defined as the image including a plurality of app icons corresponding to a plurality of apps, respectively. When one of the plurality of app icons is selected (for example, taps the icon) by the user, the control unit 170 may execute a corresponding app (for example, video player), and control display of the execution screen on the flexible display panel 112.

The key input unit 120 can include a plurality of input keys and function keys for receiving number or character information and setting various functions. The key input unit 120 generates a key event (for example, display on/off event) associated with the user setting and the function control of the apparatus 100 to transfer to the control unit 170. The control unit 170 controls the above configurations in response to the key event.

The storage unit 130, which comprises a non-transitory machine readable medium, can store the image information, for example, an image, a document, a video, a message, e-mail, music, and the like, generated in the apparatus 100 or downloaded from the outside according to the use of the apparatus 100. Further, the storage unit 130 can store the screens displayed on the touch screen 110. In addition, the storage unit 130 may store various setting values (for example, brightness, vibration in touching, and automatic rotation of screen) for the management of the portable terminal. The storage unit 130 may store various programs comprised of machine executable code. More specifically, the storage unit 130 can store an operating system (OS), a codec, an embedded application, and a 3rd party application for booting and operating of the above configurations.

The wireless communication unit 140 serves to control a voice calls, a video calls, or data communication under the control of the control unit 170. To this end, the wireless communication unit 140 can include a wireless frequency transmitter for controlling an up-conversion and amplification of a frequency of the transmitted signal and a wireless frequency receiver for controlling a low noise amplification and down-conversion of a frequency of the received signal. In addition, the wireless communication unit 140 can include a mobile communication module (e.g., a 3-generation mobile communication module, a 3.5-generation mobile communication module, or a 4-generation mobile communication module), a digital broadcast module (e.g., DMB module), and a near field communication module (e.g., a Wi-Fi module, a Bluetooth module), just to name some possibilities.

The audio processing unit 150 is coupled to the speaker (SPK) and the mike (MIC) to thereby perform an input and output functions of an audio signal for a speech recognition function, a speech duplication function, a digital recording function, and a telephone call function. In other words, the audio processing unit 150 performs the functions for outputting the audio signal through the speaker (SPK) and receiving the audio signal through the mike (MIC). The audio processing unit 150 receives the audio data from the control unit 170 to D/A convert the received audio data into the analog signal and then outputs the analog signal through the speaker (SPK). The audio processing unit 150 receives the analog signal through the MIC to A/D convert the received analog signal into the audio data and then provides the audio data to control unit 170. The SPK converts and outputs the analog signal received from the audio processing unit 150 into a sound wave. The MIC converts the sound wave transferred from a person or other sound source into the analog signal.

The transformation sensor 160 detects transformation information of the flexible display panel 112 to transfer to the control unit 170. The transformation sensor 160 may include sensors for detecting the transformation information. For example, these sensors are installed on the flexible display panel 112 as the add-on type, the on-cell type, or the in-cell type to detect the transformation information in each position.

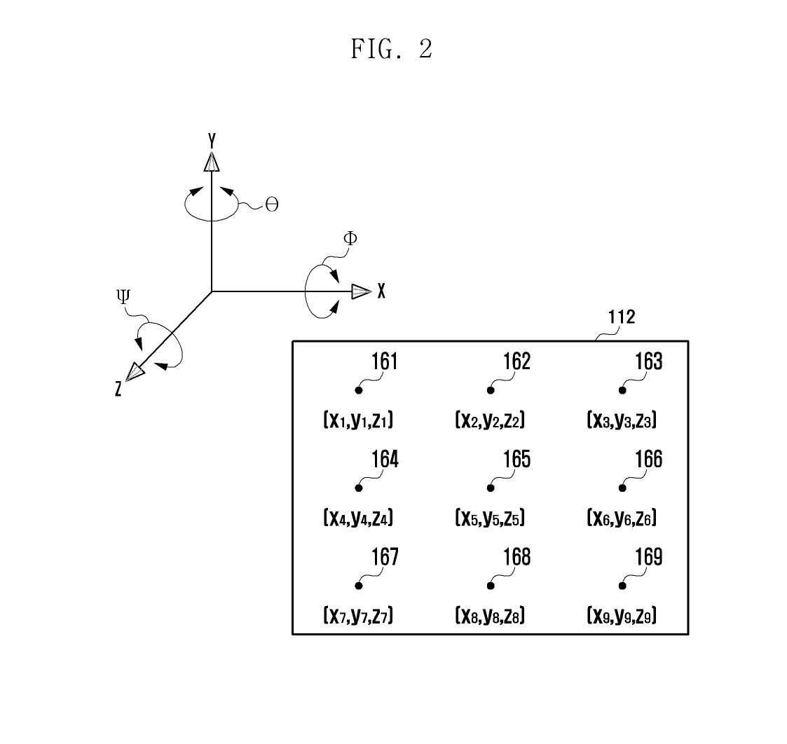

FIG. 2 is a diagram illustrating an arrangement of a transformation sensor according to an exemplary embodiment of the present invention.

Referring now to FIG. 2, the sensors 161 to 169 of the transformation sensor 160 in this example is arranged and installed on the flexible display panel 112 in a grid type. In the case in which the flexible display panel 112 is bent, distances between the sensors 161 to 169 are changed. Each of the sensors 161 to 169 generates the transformation information (for example, a change amount of voltage) corresponding to the distance change to transfer to the control unit 170. Although FIG. 2 illustrates that the number of total sensors are nine, the number nine is just given for convenience of explanation, and the present invention is not in any way limited thereto. In addition, the sensors may be arranged in different ways other than the grid type.

The control unit 170 controls an overall operation of the apparatus 100 and a signal flow between inner configurations, and serves to process the data. Then the control unit 170 controls a power supply supplied from a power source such as a battery to the inner configurations. In addition, the control unit 170 may include a central processing unit (CPU) and a graphic processing unit (GPU). Each of the CPU and the GPU may be integrated into a single package in which at least two independent cores (for example, a quad-core) are formed to provide a single integrated circuit. Further, the CPU and the GPU may be a system on chip (SoC). Furthermore, the CPU and the GPU may be formed with a multilayer package. A configuration including the CPU and the GPU may be referred to an application processor (AP).

The control unit 170 receives the transformation information from the transformation sensor 160 to calculate the degree of bending (a direction and MAGNITUDE) of the display panel 112 by using the transformation information. For example, the control unit 170 already knows an initial coordinate value of each of the sensors 161 to 169 when the flexible display panel 112 is not transformed (i.e., when the display panel is flat). Here, the initial coordinate value of each of the sensors 161 to 169 may be, for example, a relative coordinate value based on the coordinate value (for example, 0,0,0) of the sensor 165 which is positioned at a central portion. The control unit 170 detects the input of the transformation information received from the transformation sensor 160.

The control unit 170 converts the detected transformation information (for example, an amount of voltage change Δv) into an amount of position change Δx,Δy,Δz and calculates the current coordinate value of each of the sensors 161 to 169 by adding the amount of the position change to the initial coordinate value. Then, the control unit 170 calculates the angle of each of the sensors 161 to 169 by using the calculated current coordinate values. Here, the calculated angles may include a roll angle φ, a pitch angle θ, and a yaw angle ψ. Referring to FIG. 2, the roll angle θ indicates an angle based on the X axis, the pitch angle θ indicates an angle based on the Y axis, and the yaw angle ψ indicates an angle based on the Z axis.

The control unit 170 determines whether the flexible display panel 112 is bent by using angle values calculated for each of the sensors 161 to 169, and, if the flexible display panel 112 is bent, the control unit determines whether the display panel 112 is bent in a convex or concave shape.

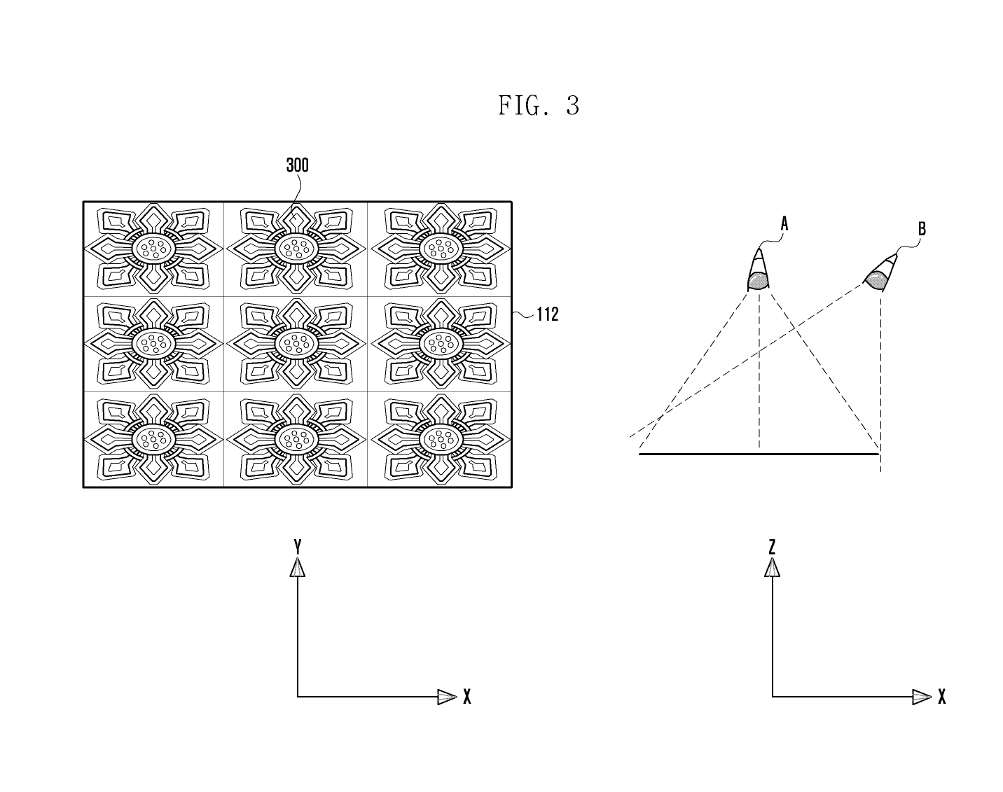

An example of a method for determining whether the display panel is bent and whether the display panel is convex or concave will be described with reference to FIGS. 3 to 5. However, the present invention is not limited thereto. That is, various methods for determining may be used.

FIGS. 3 to 5 are diagrams illustrating image information providing to a user through a display panel.

The control unit 170 sets the largest value among the roll angle φ, the pitch angle θ, and the yaw angle ψ of each of the angle values as a representative value. Then, the control unit 170 serves to average the representative value, and if the average value is within a threshold range, which, for example, ranges from −5 degrees to +5 degrees, determines that the display panel 112 is not bent (that is, flat).

If the average value departs from the threshold range, the control unit 170 determines that the flexible display panel 112 is bent. In addition, if the average value is a negative value (for example, −50 degrees), the control unit 170 determines that the display panel 112 is bent to be convex. Here, for example, the term “convex” refers to a shape that both edges of the display panel 112 are bent backwardly, that is, a shape that both edges are farther than the center when user sees the display panel 112.

If the average value is a positive value (for example, +50 degrees), the control unit 170 determines that the display panel is bent to be concave. Here, the term “concave” refers to a shape that the center of the flexible display panel 112 is bent backwardly, that is, a shape that the center is farther than the both edges when user sees the flexible display panel 112.

When the flexible display panel 112 is bent, the image information displayed on the flexible display panel 112 may appear distorted by a perspective and a viewing angle as compared with the case in which the flexible display panel 112 is flat. In other words, a phenomenon that the image information looks to be distorted occurs. For example, referring now FIG. 3, the user can see the image 300 through the flat display panel 112. In this case, the user's eyes may be positioned in a first point A which is perpendicular to the display panel 112 or be positioned in a second point B oblique in right direction (in the positive X-axis direction) with respect to the display panel 112.

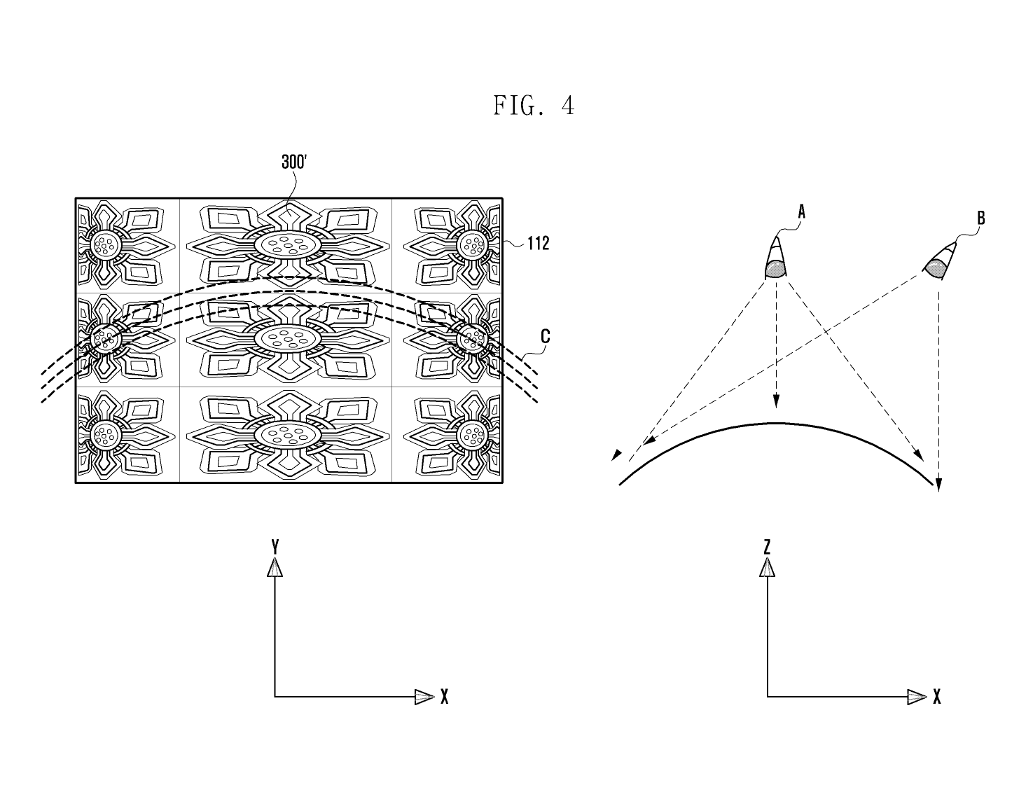

Referring now to FIG. 4, in the case in which the display panel 112 is bent, an outer portion of the image 300′ is positioned farther than the center from the position of the eye A or B. In addition, the viewing angle becomes narrow toward the outer portion. Therefore, a phenomenon that the center thereof looks like a droop may have occurred. In this case in which the eye is positioned at the second point B oblique from the display panel 112, a phenomenon C that the image 300′ appears to be drooped downwardly (in the negative Y-axis direction; see FIG. 4) toward the outer portion may be occurred together with the phenomenon that the center thereof looks like droop.

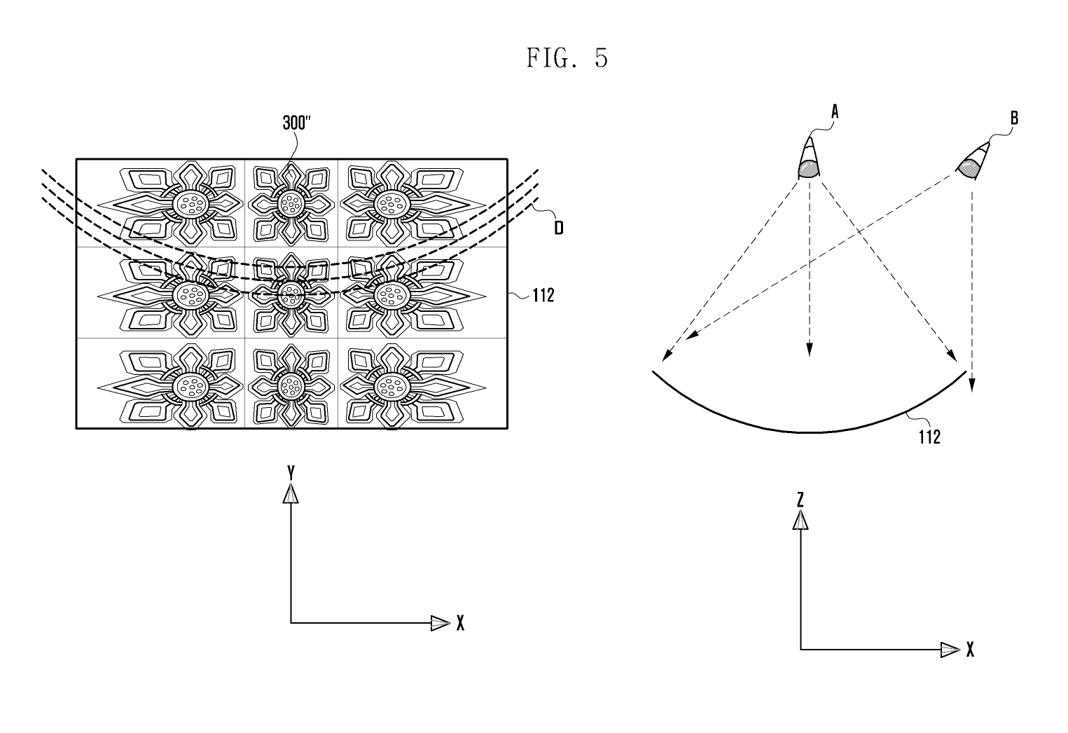

As shown in FIG. 5, in the case in which the flexible display panel 112 is bent to be concave, the center of the image 300″ is positioned farther than the outer portion thereof from the position of the eye A or B. In addition, the viewing angle becomes narrow toward the outer portion. Therefore, a phenomenon occurs that the center thereof looks relatively narrow compared to edges of the flexible display panel. In this case, in the case in which the eye is positioned at the second point B oblique from the display panel 112, a phenomenon D that the image 300′ looks to be rising upwardly (in the positive Y-axis direction; see FIG. 5) toward the outer portion can occur together with the phenomenon that the center thereof looks narrow.

In the case in which the display panel 112 is bent, the control unit 170 transforms the image information so as not to be distorted, and controls the display the transformed image information on the display panel 112. The image information transformation method will be described in more detail below.

Meanwhile, in accordance with the trend toward convergence of digital devices, a transformation of the image can occur in a variety of ways and with a variety of devices, which can include the flexible display panel being bent in a number of ways. However, the apparatus 100 of the present invention can further include, for example, configuration elements such as a GPS module, a vibration motor, and the like. In addition, in the apparatus 100 of the present invention, a specific configuration element may be excluded from the configurations or may be replaced with other configuration element(s) according to the provided form.

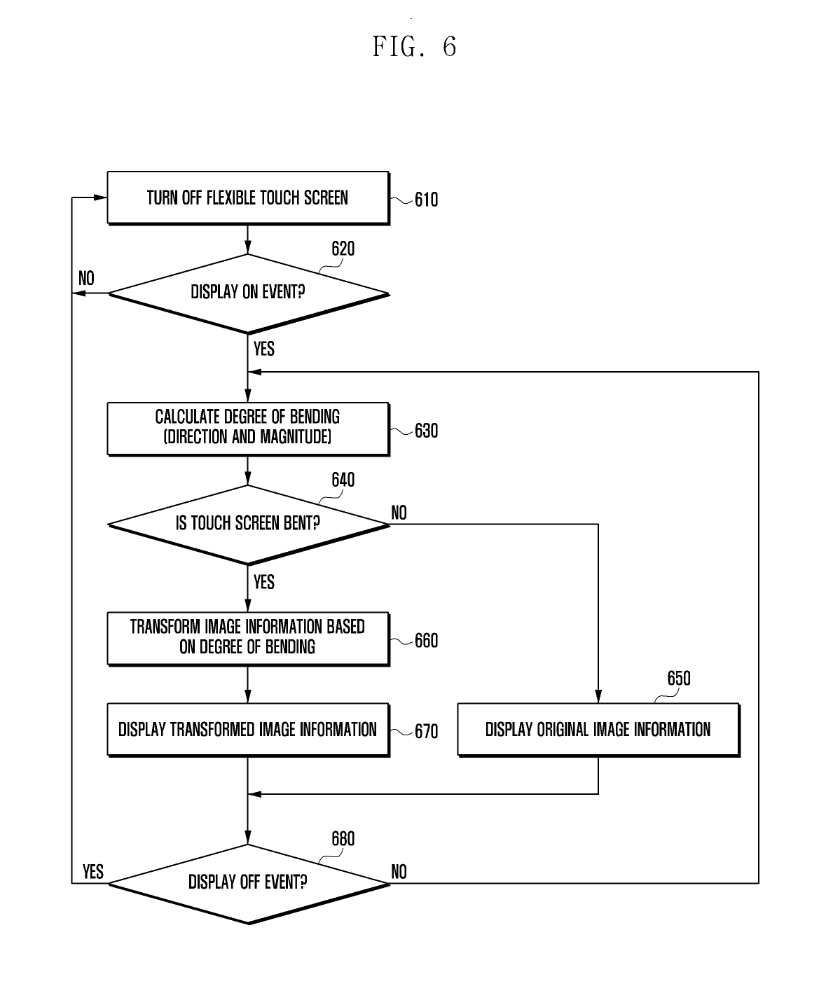

FIG. 6 is a flowchart illustrating exemplary operation of a display method according to an exemplary embodiment of the present invention.

Referring now to FIG. 6, at (610) the flexible touch screen 110 may already be an off-state or can be turned off at this step. In other words, at step 610, the control unit 170 may stop the supply of power to the flexible touch screen 110.

At (620), the control unit 170 may detect the input of the display on event from the key input unit 120.

In the case in which the display on event is detected, then at (630) the control unit 170 receives the transformation information (for example, a change amount of voltage Δv) from the transformation sensor 160, and calculates the degree of bending (for example, the angles of each of the sensors 161 to 169) of the flexible display panel 112 by using the transformation information. Here, as described above, the calculated angles may include the roll angle, the pitch angle, and the yaw angle.

At (640), the control unit 170 determines whether or not the display panel 112 is bent for each of the sensors 161 to 169 by using the calculated angle values. An example of a method for determining whether the display panel is bent was described above in detail.

In the case at (640) in which the display panel 112 is not determined to be bent, then at (650) the control unit 170 displays the original image information on the display panel 112 without any transformation of the original image.

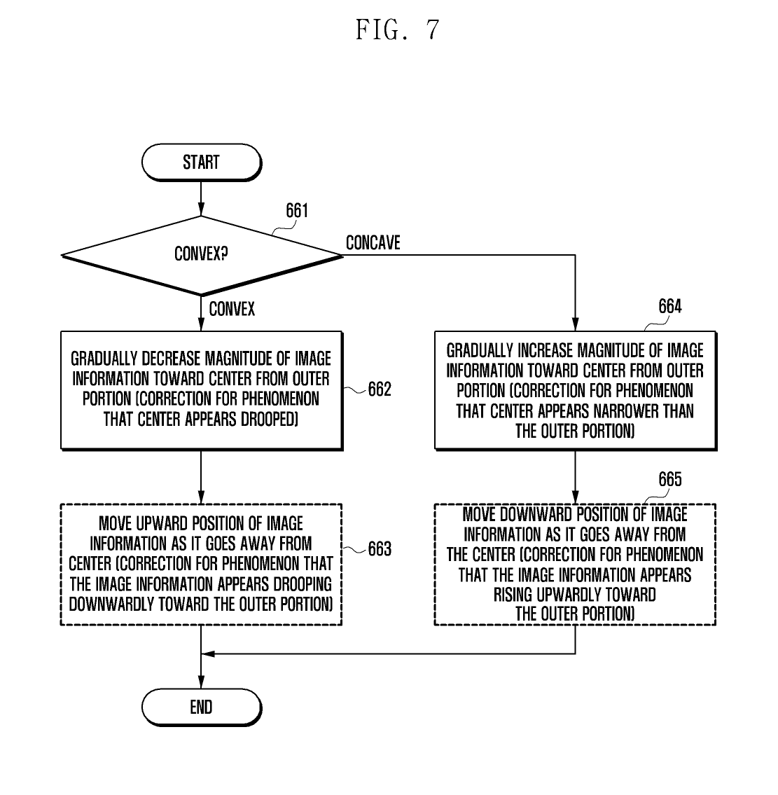

In the case at (640) in which the display panel 112 is bent, then at (660) the control unit 170 transforms the image information based on the degree of bending. Step 660 will be described in detail with reference to FIG. 7.

At (670), the control unit 170 displays the transformed image information on the display panel 112. At (680), the control unit 170 can detect the input of the display off event from the key input unit 120. In the case in which the display off event is detected, the process proceeds to re-perform step 610. Otherwise, the process may proceed to re-perform step 630.

FIG. 7 is a flowchart illustrating a transformation method of image information according to an exemplary embodiment of the present invention. FIG. 7 provides further detail about way how step (660) can be performed.

Referring now to FIG. 7, at (661) the control unit 170 determines whether the display panel 112 is convex in shape. An example of a method for determining whether the display panel is convex was described above in detail.

In the case in which the display panel 112 is convex, at (662) the control unit 170 gradually decreases the MAGNITUDE of the image information toward the center from the outer portion in order to correct the phenomenon by which the center looks drooped in comparison with the outer portion (see FIG. 4). Here, the degree of decreasing the MAGNITUDE may be proportional to the degree of bending of the flexible display panel to be convex.

At (663), the control unit 170 moves upward (in the positive Y-axis direction) the position of the image information as it goes away from the center so as to correct the phenomenon C (see FIG. 4) that the image information appears as being drooped downwardly toward the outer portion from the center. For example, in the case in which the (x, y) coordinate of a first pixel value is (5, 0), and the (x, y) coordinate of a second pixel value is (10, 0), the coordinate of the first pixel value may be changed from (5, 0) to (5, 5) and the coordinate of the second pixel value may be changed to (10, 10). Meanwhile, width of position change may be proportional to the degree of convex bending of the flexible display panel.

An artisan should appreciate that step 663 may be performed prior to step 662. In addition, step 663 can be omitted.

In the case in which the display panel 112 is concave, at (664) the control unit 170 gradually increases the MAGNITUDE of the image information toward the center from the outer portion so as to correct the phenomenon (see FIG. 5) that the center looks narrower than the outer portion. Here, the degree of increasing the MAGNITUDE may be proportional to the degree of concave bending of the flexible display panel.

At (665), the control unit 170 moves downward (in the negative Y-axis direction) the position of the image information as it goes away from the center so as to correct the phenomenon D (see FIG. 5) that the image information looks like rising upwardly toward the outer portion from the center. For example, in the case in which (x, y) coordinate of a first pixel value is (5, 0) and (x, y) coordinate of a second pixel value is (10, 0), the coordinate of the first pixel value may be changed from (5, 0) to (5, −5) and the coordinate of the second pixel value may be changed to (−10, 10). Meanwhile, the width of position change may be proportional to the degree of bending of concave.

An artisan should appreciate that step 665 can be performed prior to step 664. In addition, step 665 can be omitted.

The foregoing method of the present invention may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a complier and a high-level language code executable by a computer using an interpreter. The foregoing hardware device may be configured to be operated as at least one software module to perform an operation of the present invention.

The above-described methods according to the present invention can be implemented in hardware, firmware or as software or computer code that configures hardware for operation, and is stored on a non-transitory machine readable medium such as a CD ROM, DVD, RAM, a floppy disk, a hard disk, or a magneto-optical disk, such as a floptical disk or computer code downloaded over a network originally stored on a remote recording medium or a non-transitory machine readable medium and stored on a local non-transitory recording medium, so that the methods described herein can be loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The terms “unit” or “module” as used herein is to be understood under the broadest reasonable interpretation as constituting statutory subject matter under 35 U.S.C. §101 and does not constitute software per se.

As set forth above, the display method and the apparatus of the present invention may display the image information on the flexible display panel by transforming the image information corresponding to a degree of bending of a flexible display panel. Therefore, even when the flexible display panel is bent, the user may see undistorted image. While the examples above determined bending as being convex of concave, the invention is broad and can provide an undistorted image for other ways the flexible display panel can be bent.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A display method in a terminal having a flexible display panel, the method comprising:
calculating a degree of bending of a flexible display panel;
determining whether the flexible display panel is bent based on the calculated degree of bending;
transforming image information when the flexible display panel is bent; and
displaying an image of the transformed image information.

2. The method of claim 1, further comprising:
when the flexible display panel is determined to be bent, determining whether the bend of the flexible display panel is convex or concave;
transforming the image information when the flexible display panel is bent comprises gradually decreasing a MAGNITUDE of the image information toward a center from an outer portion when the flexible display panel is convex, and transforming the image information by gradually increasing the MAGNITUDE of the image information toward the center from the outer portion when the flexible display panel is concave; and
displaying the transformed image information to correspond to the flexible display panel being convex or display the transformed image information to correspond to the flexible display panel being concave.

3. The method of claim 1, further comprising
transforming the image information by moving upward a position of the image information being displayed away from the center when the flexible display panel is convex; and transforming the image information by moving downward the position of the image information being displayed away from the center when the flexible display panel is concave.

4. The method of claim 1, wherein the flexible display panel is convex when a shape of both edges of the flexible display panel are bent backward compared to the center when viewed from in front of the flexible display panel, and the flexible display panel is concave when a shape of the center of the flexible display panel is bent backward compared to both edges thereof when viewed from in front of the flexible display panel.

5. The method of claim 1, wherein calculating a degree of bending comprises calculating an angle of each of a plurality of sensors by using transformation information received respectively from the plurality of sensors installed on the flexible display panel.

6. The method of claim 5, wherein calculating a degree of bending comprises calculating at least one of a roll angle based on a X-axis, a pitch angle based on a Y-axis, and a yaw angle based on a Z-axis.

7. The method of claim 1, further comprising controlling voice calls, a video calls, or data communication by a wireless communication unit under the control of the control unit.

8. An apparatus in a terminal having a flexible display panel, the apparatus comprising:
a flexible display panel;
a transformation sensor unit that senses a transformation of the flexible display panel received by a plurality of sensors installed on the flexible display panel; and
a control unit controlling display of an image information by the flexible display panel based on transformation information received from the transformation sensor unit,
wherein the control unit controls the flexible display panel to calculate a degree of bending of the flexible display panel, determine whether the flexible display panel is bent based on the calculated degree of bending and when it determined that the flexible display panel is bent, transform image information to display an image of the transformed image information by the flexible display panel.

9. The apparatus of claim 8, wherein the control unit determines when the flexible display panel is bent comprises determining whether the flexible display panel is convex or concave, and transform image information by gradually decreasing a MAGNITUDE of the image information displayed toward a center from an outer portion when the flexible display panel is convex, transform the image information by gradually increasing the MAGNITUDE of the image information displayed toward the center from the outer portion when the flexible display panel is concave, and display the image information transformed to correspond to when the flexible display panel is convex or display the image information transformed to correspond to when the flexible display panel is concave.

10. The apparatus of claim 9, wherein the control unit transforms the image information by moving upward a position of the image information being displayed as it goes away from the center when the flexible display panel is convex, and transforms the image information by moving downward the position of the image information being displayed as it goes away from the center when the flexible display panel is concave.

11. The apparatus of claim 9, wherein the control unit calculates an angle of each of the plurality of sensors by using the transformation information received from the sensors, and determines whether the flexible display panel is bent based on the calculated angle of each of the plurality of sensors and whether the flexible display panel is convex or concave when the flexible display panel is determined to be bent.

12. The apparatus of claim 11, wherein the angle of each of the plurality of sensors includes at least one of a roll angle based on an X-axis, a pitch angle based on a Y-axis, and a yaw angle based on a Z-axis.

13. The apparatus of claim 9, further comprising a flexible touch panel arranged on the flexible display panel.

14. The apparatus of claim 9, further comprising a wireless communication unit under control of the control unit comprising a transceiver for controlling voice calls, video calls, or data communication.

15. The apparatus of claim 9, wherein the control unit comprises a central processing unit (CPU) and a graphic processing unit (GPU).

16. A recording medium implemented in a terminal having a flexible display panel, wherein the recording medium comprises machine executable code that when executed by a control unit configures the control unit to calculate a degree of bending of the flexible display panel, determine whether the flexible display panel is bent based on the degree of bending, determine whether the flexible display panel is convex or concave when the flexible display panel is determined to be bent, transform image information by gradually decreasing a MAGNITUDE of image information being displayed toward a center from an outer portion when the flexible display panel is convex, transform the image information being displayed by gradually increasing the MAGNITUDE of the image information toward the center from the outer portion when the flexible display panel is concave, and display the image information transformed to correspond to the flexible display panel being convex or the image information transformed to correspond to the flexible display panel being concave.
